(19) United States
(12) Patent Application Publication
(10) Pub. No.: US 2014/0269896 A1
(43) Pub. Date: Sep. 18, 2014

(54) Multi-Frame Compression

(71) Applicant: FUTUREWEI TECHNOLOGIES, INC., Plano, TX (US)

(72) Inventor: Ngoc-Dung Dao, Ottawa (CA)

(73) Assignee: FutureWei Technologies, Inc., Plano, TX (US)

(21) Appl. No.: 13/799,576

(22) Filed: Mar. 13, 2013

(51) Int. Cl. H04N 7/26

(52) U.S. Cl. CPC H04N 19/00006
USPC 375/240.02

(57) ABSTRACT

A system and method for compressing data is provided. An embodiment comprises building an adaptive global codebook for each scene in a sequence of video frames. Each frame in the sequence of frames is encoded based on a different encoding order that facilitates an efficient codebook update. Context models for the currently encoded macroblocks are based on temporally and spatially neighboring macroblocks and a global codebook.

### TECHNICAL FIELD

The present invention relates to a system and method for compressing data, and, in particular embodiments, to a system and method for compressing video data.

### BACKGROUND

As mobile devices and on-demand content has caused an increase in demand for the transfer of video and audio over networks and wireless communications, it has become more and more important to be able to transmit more information with less data across the networks. As such, there has been a rise in the importance of data compression techniques that allows this more information with less data.

One such data compression technique is known as lossy compression. In this technique information redundancy is remove within a picture frame or among multiple picture frames by such methods as integer transform, quantization, and other similar methods. However, as the name implies, the lossy compression actually entails a small loss of data that cannot be recovered during decompression.

Another type of data compression technique is known as a lossless compression. In this type of compression technique information redundancy in the symbol stream (formed during, e.g., a lossy compression technique) may be removed. In the lossless compression technique, as the name implies, there is no loss of data like in the lossly compression technique.

However, for both of these techniques, there is a need for a greater compression with a more efficient compression method than is currently available.

### SUMMARY

In accordance with an embodiment, a method of coding a sequence of frames comprising receiving a first frame at an input port and receiving a second frame at the input port is provided. A first encoding order of macroblocks is specified for the first frame and a second encoding order of macroblocks is specified for the second frame based at least in part on the encoding order of the first frame, wherein the second encoding order is different from the first encoding order.

In accordance with another embodiment, a frame encoding system comprising an input port configured to receive a first frame and a second frame and a processor is provided. The processor is configured to specify a first encoding order of macroblocks for the first frame and specify a second encoding order of macroblocks for the second frame based at least in part on the encoding order of the first frame, wherein the second encoding order is different from the first encoding order.

In accordance with yet another embodiment, a method of encoding a sequence of frames comprising receiving a first frame of a scene with a first macroblock and receiving a second frame of the scene with a second macroblock, wherein the first macroblock is a temporal neighbor of the second macroblock, is provided. The second macroblock is encoded based at least in part on a codebook generated at least in part from the first macroblock.

In accordance with yet another embodiment, a frame encoding system comprising an input port to receive a first frame of a scene and a second frame of a scene, the first frame comprising a first macroblock, the second frame comprising a second macroblock, wherein the first macroblock is a temporal neighbor of the second macroblock, is provided. A processor is coupled to the input port, the processor configured to encode the second macroblock based at least in part on a codebook generated at least in part from the first macroblock. An output port is coupled to the processor, the output port configured to output the encoded second macroblock.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a compression unit in accordance with an embodiment;

FIG. 2 illustrates a lossy compression unit in accordance with an embodiment;

FIGS. 3A-3B illustrate encoding sequences in accordance with an embodiment;

FIG. 4 illustrates a lossless compression unit in accordance with an embodiment; and

FIG. 5 illustrates the use of spatial and temporal neighboring macroblocks in accordance with an embodiment;

FIG. 6 illustrates a flow chart of a process for encoding macroblocks in accordance with an embodiment;

FIGS. 7A-7C illustrate test data in accordance with an embodiment; and

FIG. 8 is a block diagram illustrating a computing platform that may be used for implementing, for example, the devices and methods described herein, in accordance with an embodiment.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments will be described below with reference to a specific embodiment utilizing a H.264 encoding standard. Embodiment, however, are not so limited, and may be applied to any encoding methodology, including the H.265 encoding standard and any other suitable encoding methodology.

With reference now to FIG. 1, there is illustrated a block diagram of a compression unit 100 that may be used to compress a raw video sequence 101 into a compressed video sequence 101. In an embodiment the compression unit 100 may comprise a lossy compression unit 105 which initially receives the raw video sequence 101 and a lossless compression unit 107 which outputs the compressed video sequence 101. The compressed video sequence 101 may then be transmitted by any suitable method, such as over the internet, over wireless networks using an antennae and transmitters and receivers, or the like.

However, as one of ordinary skill in the art will recognize, the lossy compression unit 105 and the lossless compression unit 107, while illustrated in FIG. 1 as the only components of the compression unit 100) are merely two units that make up the compression unit 100. In addition, the compression unit 100 may also have additional units (not individually illustrated in FIG. 1) in order to assist in the encoding or management of the video sequence as it is being compressed. All such units are fully intended to be included within the scope of the embodiments.

In an embodiment the raw video sequence 101 comprises a series of individual video frames that collectively may be used to illustrate a video. The individual video frames may be digital video frames used for any type of digital communications, such as video telephony, video streaming, file storage, file transfer, combinations of these, or the like. Additionally, the frames within the raw video sequence may be any size or resolution that is desired to be transmitted.

The lossy compression unit 105 receives the raw video sequence and removes redundant information within the individual picture frames or among multiple frames within the raw video sequence 101. This removal may be performed, for example, using one or more compression techniques such as integer transform, quantization, prediction, combinations of these, or the like (described further below with respect to FIG. 2).

The lossless compression unit 107 receives the output of the lossy compression unit 105 and further compresses the video sequence. In an embodiment the lossless compression unit 107 further compresses the stream by removing redundant information within the stream from the lossy compression unit 105, and can use source coding techniques such as universal variable length code (UVLC), context adaptive variable length code (CAVLC), context adaptive binary arithmetic code (CABAC), combinations of these, or the like (as described further below with respect to FIG. 4). However, any suitable method for lossless compression may alternatively be utilized. The lossless compression unit 107 outputs the compressed video sequence 101 for transmission.

FIG. 2 illustrates a block diagram of a video encoder 200 that may be used to implement the lossy compression unit 105 in FIG. 1. In an embodiment the video encoder 200 may have an input port 201 to receive the raw video sequence 101. In an embodiment the raw video sequence 101 is analyzed by the compression unit 100 on a scene-by-scene basis, with each scene comprising a series of individual frames that are similar to each other, such as by having similar backgrounds or characters within the individual frames.

To separate the individual frames of the raw video sequence 101 into separate scenes, the compression unit 100 utilizes an algorithm in order to determine when the raw video sequence 101 changes scenes. For example, in an embodiment the compression unit 100 may monitor variations in a sum of absolute transformed differences (SATD) on a frame by frame basis. Then, for each frame, a motion residual ratio (MMR) test may be performed where a ratio of a current frame's SATD and a previous frame's SATD is determined and compared to a statistical control parameter. If the ratio is greater than the statistical control parameter, a scene change has occurred. If not, no scene change has occurred. This method is described in greater detail in the paper “Adaptive group-of-pictures and scene change detection methods based on existing H.264 advanced video coding information,” by J.-R. Ding and J.-F. Yang, IET Image Process, 2008, Vol. 2, No. 2 pp. 85-94, which is incorporated herein by reference.

Within each scene, the raw video sequence 101 will be split into a series of frames such as frame n, n+1, n+2, etc. Additionally, each of the individual frames is also sub-divided further into a series of macroblocks 204, known as slices of the frame (not individually illustrated). The individual frames may be subdivided into any suitable number of macroblocks 204, such as a 16×16 grid of macroblocks 204, an 8×16 grid, a 16×8 grid, an 8×8 grid, a 4×8 grid, an 8×4, a 4×4, or the like. However, any suitable grid of any size macroblocks may alternatively be utilized.

FIG. 3A illustrates an embodiment of a picture group using a grid of 5×5 macroblocks 204 for each frame, for a total of 20 macroblocks 204 per frame, being fed into the lossy compression unit 105 illustrated in FIG. 2 in a jointly decided encoding sequence. This picture group, which may comprise a greater number of picture frames than the two illustrated in FIG. 3A, is losslessly compressed together. In an embodiment, all of the pictures within the picture group are in the same scene, although multiple picture groups may also be within the same scene.

In an alternative embodiment, the individual frames may also be subdivided into one or more slices, such as two slices per frame. In such an embodiment all of the macroblocks 204 within the individual slices may be compressed together in the jointly decided encoding sequence. For example, if there are two slices in a picture frame, such as a first slice and a second slice, all of the macroblocks 204 within the first slice may be compressed together, and all of the macroblocks 204 within the second slice may be compressed together, although any suitable number of slices can alternatively be used.

Additionally, as one of ordinary skill in the art will recognize, the use of 20 macroblocks 204 for each frame as illustrated in FIG. 3A is intended to be illustrative only, as many more macroblocks 204 may be utilized to fully encode the individual frames of the raw video sequence 101. Any suitable number of macroblocks 204 may be used.

In a particular embodiment, in a first frame 301 (also labeled as frame 2n in FIG. 3A), the encoding sequence feeds the macroblocks 204 into the lossy compression unit 105 starting with a top left macroblock 204 labeled macroblock “1” in the first frame 301 of FIG. 3A. Then working to the right of the first frame 301, the macroblocks 204 in the same row as the original macroblock 204 are fed into the lossy compression unit 105 until the end of the first row of the first frame 301 is reached. Once a row's last macroblock 204 is reached in a left-to-right manner, the next row of macroblocks 204 in the first frame 301 are input, starting with the left-most macroblock 204 (labeled macroblock “6” in the first frame 301 in FIG. 3A). This continues in a left-to-right, up-to-down fashion, until all of the macroblocks 204 within the first frame 301 have been fed into the lossy compression unit 105.

However, while the first frame 301 is encoded in a left-to-right, up-to-down sequence, a second frame 303 (also labeled in FIG. 3A as frame 2n+1) is encoded in such a fashion as to enhance the coding efficiency of the second frame 303 in relation to the first frame 301. In a particular example, the second frame 303 may be encoded using a different sequence of macroblocks 204 than the first frame 301 and instead of beginning the encoding sequence at the top-left most macroblock 204, for the second frame 303 the encoding sequence may first send the bottom-right most macroblock 204 (labeled in the second frame 303 of FIG. 3A as macroblock “1”) to the lossy compression unit 105. The next macroblock would then be the macroblock 204 to the immediate left of the first macroblock, and the encoding sequence will continue to the left, finally sending the leftmost macroblock 204 (labeled macroblock “5” in the second frame 303 in FIG. 3A) in the bottom row. Once the bottom row of macroblocks 204 has been sent, the next lowest row of macroblocks 204 may be sent, continuing in a right-to-left, bottom-to-top sequence of sending the macroblocks 204 to the lossy compression unit 105.

However, as one of ordinary skill in the art will recognize, the right-to-left, bottom-to-top sequence of macroblocks 204 is not the only encoding sequence that may be utilized for the second frame 303. Rather, any suitable sequence other than the coding sequence of the first frame 301 may alternatively be utilized as long as the coding sequences for both the first frame 301 and the second frame 303 are jointly decided. For example, FIG. 3B illustrates a left-to-right, bottom-to-top coding sequence that may alternatively be utilized. This and any other suitable coding sequence may be used, and all such coding sequences are fully intended to be included within the scope of the embodiments.

Returning to FIG. 2, the individual macroblocks 204 in the appropriate sequences are sent to a subtractor 203 one at a time, wherein data from an image prediction (an output from the motion compensation unit 205, discussed further below) is subtracted from each of the macroblocks 204. This subtraction generates a first residual image data for each of the macroblocks 204 that were part of the raw video sequence 101.

Once the first residual image data has been generated, the subtractor 203 will send the first residual image data to a transformation/scaling/quantization unit 207. In an embodiment the transformation/scaling/quantization unit 207 is used to reduce the statistical correlation of the macroblocks 204 such that only a small number of variable is needed to represent the most relevant aspects of the first residual image data of each of the individual macroblocks 204. For example, the transform may be performed using a discrete cosine transform of the first residual image data or a Karhunen-Loeve transform, although any suitable transform may alternatively be utilized. The transform will generate coefficient data representative of the first residual image data.

The transformation/scaling/quantization unit 207 performs a quantization of the coefficient data representative of the first residual image data. In an embodiment, the transformation/scaling/quantization unit 207 will reduce the precision of the coefficient data from the transformation and form quantized transformation coefficient data. In an embodiment the quantization process will multiply the coefficient data representative of the first residual image data by a quantization scale factor, divide the coefficient data from the transformation by a given step size, and then round the result to obtain quantized transformation coefficient data. However, any other suitable quantization method may alternatively be utilized.

The quantized transformation coefficient data is then sent to both the lossless compression unit 107 (described further below with respect to FIG. 4) and also to an inverse transformation unit 209. The inverse transformation unit 209 may receive the quantized transformation coefficient data from the transformation/scaling/quantization unit 207 and performs an inverse transformation of the quantized transformation coefficient data. For example, in an embodiment in which the transformation/scaling/quantization unit 207 used a discrete cosine transformation, the inverse transformation unit 209 will perform an inverse discrete cosine transformation and generate second residual image data from the quantized transformation coefficient data.

The second residual image data is sent to an adder 211, which adds the second residual image data to the image prediction (the output from the motion compensation unit 205). This addition generates a decoded image data 206 of the macroblock 204, which is then forwarded to an intra-frame estimation unit 213, an intra-frame prediction unit 215, and a deblocking filter 217.

The intra-frame estimation unit 213 and the intra-frame prediction unit 215 are used to collectively generate a predicted frame to be sent, e.g., to the subtractor 203 when motion compensation is not available (e.g., for the first frame 301 of a scene). In an embodiment the intra-frame estimation unit 213 and the intra-frame prediction unit 215 generate a prediction based upon knowledge of pixels in surrounding macroblocks 204 of the same frame that have already been decoded to create a prediction of the new block. For example, the intra-frame estimation unit 213 and the intra-frame prediction unit 215 can form predictions as linear interpolations from neighboring macroblocks 204 that have already been encoded. Once a predicted frame has been generated, the predicted frame is sent to the subtractor 203.

The deblocking filter 217 is utilized to filter and remove blocking and quantization noise that may have occurred during the quantization process while attempting to maintain the content of the image. Such removal may be performed by initially deriving a boundary strength for each horizontal and vertical edge of a block and then, if the boundary strength is large enough, the individual pixels are modified to remove the noise. Once the decoded image has passed through the deblocking filter 217, the filtered decoded image 208 is stored, e.g., in a filtered decoded image data buffer, and can be sent to the motion compensation unit 205.

The motion estimator unit 219 receives the unencoded macroblocks 204 from the input port 201. Based on this unencorded macroblock 204 and one or more reference macroblocks 204 (e.g., the filtered decoded image 208 stored in the filtered decoded image buffer) the motion estimator unit 219 generates a motion vector and a prediction motion vector. Once the motion vector and prediction motion vector have been determined, the motion estimator unit 219 will forward the motion vector to the motion compensation unit 205.

The motion compensation unit 205 receives the motion vector and applies the motion vector to a reference frame from the filtered decoded picture buffer (storing filtered decoded picture 208). In an embodiment the motion compensation unit 205 uses a compensation method such as global motion compensation, block motion compensation, variable clock-size motion compensation, overlapped block motion compensation, quarter pixel and half pixel motion compensation, combinations of these, or the like. The resulting motion compensated frame is then sent to the subtractor 203 to be subtracted from the macroblock 204.

A coder control unit 223 is utilized to control the various units within the encoder 200. For example, the coder control unit 223 provides control data to the transform/scaling/quantization unit 207, the scaling and inverse transformation unit 209, the intra-frame estimation unit 213, the intra-frame prediction unit 215, the motion estimator unit 219, the motion compensation unit 205 as well as sending control data to the lossless compression unit 107.

The quantized transformation coefficient data is also sent from the transformation/scaling/quantization unit 207 and sent to the lossless compression unit 107 for further compression before transmission. In an embodiment the lossless compression unit 107 utilizes an entropy encoding technique such as a source coding technique in order to remove redundancies within the quantized transformation coefficient data. For example, the lossless compression unit 107 uses a source coding technique such as context adaptive binary arithmetic code (CABAC) in order to further compress the quantized transformation coefficient data, although other suitable source coding techniques, such as universal variable length code (UVLC) or context adaptive variable length code (CAVLC), may alternatively be used.

FIG. 4 illustrates an embodiment of the lossless compression unit 107 in which the lossless compression unit 107 uses CABAC. In such an embodiment the entropy encoder 225 has a binarization unit 401, a context modeler 403, a regular coding engine 405, a bypass coding engine 407, and a codebook storage unit 409. The binarization unit 401 is used to receive the nonbinary valued syntax elements that may be in the quantized transformation coefficient data and map them to a binary sequence known as a bin string. In an embodiment this mapping is performed using a unary and truncated unary binarization scheme, a kth order Exp-Golomb Binarization Scheme, a fixed-length binarization scheme, or a concatenation of these schemes, although any other suitable binarization scheme may alternatively be utilized.

Additionally, if the quantized transformation coefficient data is already received in a binary format, then no binarization is needed. In such an embodiment the quantized transformation coefficient data may bypass the binarization unit 401 and proceed directly to either the context modeler 403 (if a regular path is chosen) or else to the bypass coding engine 407 (if a bypass path is chosen).

If the regular path is chosen, the binary bin string is received at the context modeler 403. The context modeler 403 will, for each bin sting, select from the codebook storage unit 409 a context model or codebook to apply to the bin string. In an embodiment the codebook may be selected from either an initial codebook, a local codebook, or an overall codebook.

The initial codebook is utilized for the first macroblock 204 of each scene (or other group of frames) that arrives at the context modeler 403 to be encoded. As there are no neighboring macroblocks 204 to be used as predictors, the initial codebook may be a codebook that is based upon assumptions to be used as a starting point (before adaptation) for the first macroblock 204. For example, in an embodiment methods such as the methods described in the H.264 and H.265 standards may be utilized to initialize the initial codebook. Alternatively, the initial codebook may be generated from general statistics of previous scenes that have already been encoded. Any suitable codebook that may be used to encode the first macroblock 204 of each scene.

A local codebook is utilized for subsequent macroblocks 204 once the first macroblock 204 has been encoded. In an embodiment the local codebooks are predictive codebooks that are built on the fly for each macroblock 204, and are based on a modeling function of the global codebook and the bin values from neighboring macroblocks 204 that have already been encoded. FIG. 5 illustrates one such example in which macroblock 204 “13” in the second frame 303 is desired to be encoded. For this macroblock 204, spatially neighboring macroblocks 204 “7,” “8,” “9,” and “12” in the second frame 303 which have already been encoded in the right-to-left, bottom-to-top sequence discussed above, are used to predict the codebook for macroblock 204 “13.”

However, in addition to using the spatially neighboring macroblocks 204, embodiments also use temporally neighboring macroblocks 204. In a particular example wherein the first frame 301 has been encoded prior to the second frame 303, macroblocks 204 in the first frame 301 that temporally neighbor the macroblock 204 being encoded, such as macroblocks 204 “2,” “3,” “4,” “7,” “8,” “9,” “12,” “13,” “14,” in the first frame 301 may also be used.

Additionally, while the above embodiment describes using neighboring macroblocks 204 that are immediately adjacent to the macroblock 204 being encoded, the embodiments are not intended to be limited as such. Rather, any previously encoded macroblock 204 which might be useful in the prediction or generation of the codebook for the macroblock 204 currently being encoded, no matter the spatial or temporal distance away from the macroblock 204 currently being encoded, may alternatively be utilized. All such macroblocks 204 are fully intended to be included within the scope of the embodiments.

Benefits of this encoding order may also be seen with respect to the first macroblock 204 encoded in the second frame 303 (the macroblock 204 labeled “1” in the second frame 303. If only spatially neighboring macroblocks 204 were used, there would be no neighboring macroblocks 204 to use (as the first macroblock 204 in the frame is encoded first). However, by using temporally neighboring blocks, such as macroblocks “14,” “15,” “19,” and “20” of the first frame 301, similar macroblocks 204 may be utilized to generate the codebook for the first macroblock 204 encoded in then second frame 303.

Alternatively, if it is desirable to not use the neighboring macroblocks 204, a global codebook may be utilized. In an embodiment the global codebook is a codebook that is built on the fly and stores the statistics of video coded symbols of all macroblocks 204 of all of the previously encoded frames. This global codebook may be applied without reference to the neighboring macroblocks 204 as described above with respect to the local codebooks. Each type of frame (independently decodable frames, predictive frames, and bi-directionally predictive frames), may have their own separate global codebook.

In another embodiment, both the global codebook and the neighboring macroblocks 204 (both temporally and spatially) may be utilized to predict the codebook for the macroblock 204 currently being encoded. For example, the global codebook and the neighboring macroblocks 204 may be weighted so that a final codebook utilizing both may be achieved and utilized to encode the macroblock 204.

In yet another embodiment, the predicted codebook for a macroblock 204 may be generated using the codebooks of neighboring macroblocks 204 (both temporally and spatially) along with a codebook for a previous slice of macroblocks 204. For example, in an embodiment in which the second frame 303 has the first slice of macroblocks 204 and the second slice of macroblocks 204, then a macroblock 204 being encoded in the second slice may use neighboring macroblocks 204 along with a codebook of the first slice of macroblocks 204. Additionally, if desired, instead of using a codebook from the first slice from the second frame 303, a codebook from a slice of macroblocks 204 from previous frames, such as a codebook from of a slice from the first frame 301, may be utilized to generate the predictive codebook for the current macroblock 204.

Once the context model has been chosen for the bin string, the bin string and its associated context model are forwarded to the regular coding engine 305. In an embodiment the coding engine performs a table-based binary arithmetic coding, and performs three functions to code the bin strings according to their associated context models. These functions include interval subdivision, renormalization and carry-over control, and termination.

In internal subdivision, the current interval is first subdivided according to the probability estimates supplied by the chosen context model. In particular, a current interval range R is approximated by a quantized value Q(R) using an equal partition into four cells of the entire range 2⁸≦R<2⁹. Then, a quantizer index ρ of Q(R), which can be computed by a shift and bit-masking operation such as ρ=(R>>6)&3, is put into a 2-D table (which has been pre-computed to contain all of the product values in, e.g., an 8-bit precision) along with a probability state index a to determine the least probable symbol (LPS).

A sub-interval range may then be determined for the most probable symbol (MPS). For example, if the subinterval corresponding to the given bin value is equal to the MPS value, a lower subinterval is chosen. Otherwise, the upper subinterval with the range equal to the least probable symbol (R_{LPS}) is chosen. This procedure is performed recursively, with each iteration having a smaller and smaller range from which to choose.

Once the interval subdivision is performed, a renormalization step and a termination step are performed. In an embodiment the renormalization step is utilized to prevent degradation of the precision of the arithmetic coding, and may be performed using, e.g., an arithmetic algorithm whereby the ranges are iteratively renormalized. Once the output has been renormalized, the process is terminated and the compressed video sequence 101 is transmitted.

As a final step in the encoding process of the bin string, the context model for each macroblock 204 is updated. For example, in an embodiment after the macroblock 204 has been encoded, the probability models within the context model for the macroblock 204 is updated by updating the encoded symbols identified as either LPS or MPS. As such, new probability states are derived, along with the associated modified LPS probability estimates and MPS estimates. Such an updating is performed for both the local codebook (for the macroblock 204 being encoded) which also updates the global codebook, thereby providing an adaptive global codebook. The update of the global codebook may be performed for either all of the frames within the same scene or else, alternatively, may be performed for all of the scenes of the whole video being encoded.

Additionally, if desired, the binary bin string, instead of being sent to the regular encoding engine 405, may alternatively be sent to the by-pass coding engine 407. In this embodiment the internal subdivision is performed such that two equally sized subintervals are provided in each interval subdivision stage, thereby bypassing the need for the context models. These equal ranges are then used in the interval subdivision as described above.

Once all of the macroblocks 204 for each of the frames within a scene has been encoded and a new scene has been determined, a reset of the codebooks is performed. As such, using the scene detection described above with respect to FIG. 1, once a scene change is detected, the adaptive global codebook is reset, and the global codebook is utilized for the next macroblock 204 of the first frame 301+1 in the new scene. By resetting the codebooks for each scene, an adaptive global codebook may be formed for each scene, and updates from the old scene will not be used in the new scene, thereby preventing undesired and/or inefficient coding in the first couple of macroblocks 204 of the new scene (before the adapting codebooks start to adapt to the new scene).

FIG. 6 illustrates a flow chart that may be used in an embodiment to encode a picture group. In a first step, a new picture frame from a new scene and a global codebook are received in a first step 601. In a second step 603 the order the frames are separated into macroblocks 204 and the encoding sequence of the macroblocks 204 is determined. In a third step 605 the individual macroblocks 204 are initialized. If it is the first macroblock 204, the global codebook is provided. Otherwise, the structure of the local codebook is provided.

In a fourth step 607 the codebook of the video elements of the current macroblock are predicted based upon the global codebook as well as previously encoded neighboring (both spatially and temporally) macroblocks 204. Once a prediction has been made, the current macroblock 204 is encoded, and the global codebook and local codebook are updated based upon the actual encoded macroblock 204. Finally, in a fifth step 609, if this is the last macroblock 204, then the encoding is ended in a sixth step 611. If it is not the last macroblock 204, then the process is repeated on a macroblock 204 by macroblock 204 basis.

By utilizing the methods and systems described above, anywhere from a 1% to a 9.4% increase in compression efficiency may be obtained. For example, FIG. 7A illustrates test results utilizing a video of a flower vase, which has both a static camera and a moving camera where the speed of a scene change is slow, a 1%-2% improvement may be obtained. In particular, using a group-of-pictures of 30 at a resolution of 416×240 (with a single slice per frame), the improved context modeling methodology described above can result in a 216 Kbit/s coding rate, which is an improvement of 1.2% over the baseline coding rate of 218.53 Kbits/s. Similarly, for a group-of-picture size of 150, the improved context modeling methodology described above can result in a 187.9 Kbit/s coding rate, which is an improvement of 1.1% over the baseline coding rate of 189.96 Kbits/s.

Similarly, if two slices per frame are used, for a group-of-picture size of 30, the improved context modeling methodology described above can result in a 221.62 Kbit/s coding rate, which is an improvement of 1.5% over the baseline coding rate of 225 Kbits/s. Similarly, if the group-of-pictures size is 150, the improved context modeling methodology described above can result in a 192.59 Kbit/s coding rate, which is an improvement of 2.2% over the baseline coding rate of 196.99 Kbits/s.

FIG. 7B illustrates result of a test performed using a video of a typical cinema movie with human motion and a moving camera, which has a medium scene change speed. In this test, for a video with 832×480 resolution, 30 frames, a group-of-picture size of 30, a frame is divided into 4 slices. The baseline scheme is that each slice is encoded separately. If 2 slices per frame are compressed together, this results in an encoding rate of 175.26 Kbit/s (for a 2.8% improvement). If four slices per frame are compressed together, this results in an encoding rate of 186.41 Kbit/s (for a 9.4% improvement). Similarly, for a sample of 300 frames, if two slices per frame are compressed together, this results in a coding rate of 457.99 (for an improvement of 2.5%).

FIG. 7C illustrates results of a test performed using a video sequence of a basketball pass in a basketball game, where the scene changes at a fast speed. In this test the video had a resolution of 416×240 and 25 frames were used. As before, when more slices are utilized, such as the two slices per frame tested, for a group-of-pictures size of 25, the coding rate 705.74 is a 1.2% improvement over.

Once the frames within the picture group have been encoded and are ready for transmission, a header is placed on the encoded picture frames (or on each separate packet of data if the encoded picture frames are separated for transmission). This header may include the information on the multi-frame compression, including the number of frames that were compressed together, a global codebook construction update mode, how the predictive codebook is built based on the codebooks of neighboring macroblocks and the global codebook, and the encoding orders of the macroblocks of the pictures. This information is placed into the header and the compressed picture frame is transmitted to a receiver (not individually illustrated).

The receiver may be any type of receiver, including wired and wireless receivers, and may receive the compressed picture frames that include the header. The receiver will also comprise a decoder that receives the information on the multi-frame compression and, utilizing the opposite process of the encoding process described above, will decode the compressed picture frames to recreate the picture frames. These frames may then be stored, viewed, or even forwarded once they have been decoded and decompressed.

FIG. 8 is a block diagram of a processing system 800 that may be used for implementing the methods and devices disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit 801 equipped with one or more input/output devices 803, such as a speaker, microphone, mouse, touchscreen, keypad, keyboard, printer, display, and the like. The processing unit may include a central processing unit (CPU) 805, memory 807, a mass storage device 809, a video adapter 811, and an I/O interface 813 connected to a bus 819.

The bus 819 may be one or more of any type of several bus architectures including a memory bus or memory controller, a peripheral bus, video bus, or the like. The CPU 805 may comprise any type of electronic data processor. The memory 807 may comprise any type of system memory such as static random access memory (SRAM), dynamic random access memory (DRAM), synchronous DRAM (SDRAM), read-only memory (ROM), a combination thereof, or the like. In an embodiment, the memory 807 may include ROM for use at boot-up, and DRAM for program and data storage for use while executing programs.

The mass storage device 809 may comprise any type of storage device configured to store data, programs, and other information and to make the data, programs, and other information accessible via the bus. The mass storage device 809 may comprise, for example, one or more of a solid state drive, hard disk drive, a magnetic disk drive, an optical disk drive, or the like.

The video adapter 811 and the I/O interface 813 provide interfaces to couple external input and output devices to the processing unit 801. As illustrated, examples of input and output devices include the display coupled to the video adapter 811 and the mouse/keyboard/printer coupled to the I/O interface 813. Other devices may be coupled to the processing unit 801, and additional or fewer interface cards may be utilized. For example, a serial interface card (not shown) may be used to provide a serial interface for a printer.

The processing unit 801 also includes one or more network interfaces 815, which may comprise wired links, such as an Ethernet cable or the like, and/or wireless links to access nodes or different networks. The network interface 815 allows the processing unit 801 to communicate with remote units via the networks 817. For example, the network interface 815 may provide wireless communication via one or more transmitters/transmit antennas and one or more receivers/receive antennas. In an embodiment, the processing unit 801 is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of coding a sequence of frames, the method comprising:
receiving a first frame at an input port;
receiving a second frame at the input port;
specifying a first encoding order of macroblocks for the first frame; and
specifying a second encoding order of macroblocks for the second frame based at least in part on the encoding order of the first frame, wherein the second encoding order is different from the first encoding order.

2. The method of claim 1, wherein the first encoding order is a left-to-right, top-to-bottom encoding sequence and the second encoding order is a right-to-left, bottom-to-top encoding sequence.

3. The method of claim 1, wherein the first encoding order is a left-to-right, top-to-bottom encoding sequence and the second encoding order is a left-to-right, bottom-to-top encoding order.

4. The method of claim 1, further comprising encoding the macroblocks at least in part with a lossless compression unit.

5. The method of claim 4, wherein the lossless compression unit uses a scene specific adaptive global codebook to encode the macroblocks.

6. The method of claim 5, wherein the scene specific adaptive global codebook resets for each scene of the sequence of frames.

7. The method of claim 5, wherein the lossless compression unit encodes one macroblock using a codebook developed from both the current frame and at least one previously encoded frame.

8. The method of claim 7, wherein the at least one previously encoded frame further comprises at least two frames.

9. The method of claim 5, wherein the lossless compression unit encodes one macroblock using a codebook developed from a slice of macroblocks.

10. The method of claim 4, further comprising:
generating encoding information;
placing the encoding information into a header; and
attaching the header to a result of the encoding the macroblocks.

11. A frame encoding system comprising:
an input port configured to receive a first frame and a second frame; and
a processor configured to:
specify a first encoding order of macroblocks for the first frame; and
specify a second encoding order of macroblocks for the second frame based at least in part on the encoding order of the first frame, wherein the second encoding order is different from the first encoding order.

12. The frame encoding system of claim 11, wherein the first encoding order is a left-to-right, top-to-bottom encoding sequence and the second encoding order is a right-to-left, bottom-to-top encoding sequence.

13. The frame encoding system of claim 11, wherein the first encoding order is a left-to-right, top-to-bottom encoding sequence and the second encoding order is a left-to-right, bottom-to-top encoding order.

14. The frame encoding system of claim 11, further comprising a lossless compression unit configured to compress the macroblocks.

15. The frame encoding system of claim 14, wherein the lossless compression unit is configured to use a scene specific adaptive global codebook to encode the macroblocks.

16. The frame encoding system of claim 15, wherein the lossless compression unit is configured to reset the scene specific adaptive global codebook resets for each scene of the sequence of frames.

17. The frame encoding system of claim 15, wherein the lossless compression unit encodes one macroblock using at least one macroblock from the first frame and at least one macroblock from the second frame.

18. The frame encoding system of claim 15, wherein the at least one previously encoded frame further comprises at least two frames.

19. The frame encoding system of claim 14, wherein the processor is further configured to:
generate encoding information;
place the encoding information into a header; and
attach the header to a result of the encoding the macroblocks.

20. A method of encoding a sequence of frames, the method comprising:
receiving a first frame of a scene with a first macroblock;
receiving a second frame of the scene with a second macroblock, wherein the first macroblock is a temporal neighbor of the second macroblock; and
encoding the second macroblock based at least in part on a codebook generated at least in part from the first macroblock.

21. The method of claim 20, wherein the codebook is also generated from a third macroblock, wherein the third macroblock is a spatial neighbor of the second macroblock.

22. The method of claim 20, further comprising:
specifying a first encoding order of macroblocks in the first frame; and
specifying a second encoding order of macroblocks in the second frame, the second encoding order being different from the first encoding order.

23. The method of claim 20, further comprising updating the codebook after the encoding the second macroblock.

24. The method of claim 20, further comprising determining for each frame whether there has been a scene change.

25. The method of claim 24, further comprising resetting the codebook when a scene change has been detected.

26. A frame encoding system comprising:
an input port to receive a first frame of a scene and a second frame of a scene, the first frame comprising a first macroblock, the second frame comprising a second macroblock, wherein the first macroblock is a temporal neighbor of the second macroblock;
a processor coupled to the input port, the processor configured to encode the second macroblock based at least in part on a codebook generated at least in part from the first macroblock; and
an output port coupled to the processor, the output port configured to output the encoded second macroblock.

27. The frame encoding system of claim 26, wherein the codebook is generated at least in part on a third macroblock within the second frame, the third macroblock being a spatial neighbor to the second macroblock.

28. The frame encoding system of claim 26, wherein the processor is further configured to:
specify a first encoding order of macroblocks in the first frame; and
specify a second encoding order of macroblocks in the second frame, the second encoding order being different from the first encoding order.

29. The frame encoding system of claim 26, wherein the processor is further configured to update the codebook after the encoding the second frame of the scene.

30. The frame encoding system of claim 26, wherein the processor is further configured to determine for each frame whether there has been a scene change.

31. The frame encoding system of claim 30, wherein the processor is further configured to reset the codebook when a scene change has been detected.
